(19) United States
(12) Patent Application Publication
(10) Pub. No.: US 2004/0172169 A1
(43) Pub. Date: Sep. 2, 2004

(54) Method and apparatus for compouding individualized dosege forms

(76) Inventors: Curtis Wright IV, Norwalk, CT (US); Benjamin Oshlack, New York, NY (US)

Correspondence Address: JONES DAY, 222 EAST 41ST ST, NEW YORK, NY, 10017, US

(21) Appl. No.: 10/469,799

(22) PCT Filed: Feb. 28, 2002
(86) PCT No.: PCT/US02/06326

Related U.S. Application Data
(60) Provisional application No. 60/272,766, filed on Mar. 2, 2001.

(51) Int. Cl. G05B 21/00

(52) U.S. Cl. 700/265

(57) ABSTRACT

The present invention provides a computer-controlled apparatus 5 and method for compounding individualized dosage forms to fill an individual patient prescription. The apparatus 5 includes a dosing unit 30 and an automated compounder 25 for compounding bulk drugs 10 into dosage forms. The apparatus 5 may also include integrated quality assurance devices 45. This method and apparatus 5 allows a pharmacist to compound dosage forms having individualized release characteristics or unique combinations of drugs that are not commercially available.

### TECHNICAL FIELD

The present invention relates to a method and apparatus for compounding dosage forms, and, more particularly, to an improved apparatus and method for compounding bulk drugs by a pharmacist for an individual patient prescription.

### BACKGROUND OF THE INVENTION

Current pharmaceutical practice generally provides for the supply of either bulk drug substances or finished drug products to the pharmacist. As a result, the pharmacist is limited to compounding only bulk drug substances that are commercially available. Also, the pharmacist is limited to the compounding of immediate release or untested controlled-release dosage forms for drug products provided as single agents or combinations. The cost and regulatory barriers associated with development of particular combinations of agents or individual patient-specific pharmacokinetic absorption profiles results in only a limited number of such products being available in the marketplace. Thus, doctors are limited in their ability to treat their patients.

Accordingly, there is a need in the art for a method for compounding individualized dosage forms such as patient-specific combinations or dosage forms with individualized release characteristics. There is also a need for a method and apparatus capable of effecting savings and improving the quality of combination and sustained-release dosage forms compounded by a pharmacist. There is also a need for compounding controlled-characteristic bulk drug formulations into individual patient prescriptions.

### SUMMARY OF THE INVENTION

The present invention addresses the above needs by providing a method and apparatus for compounding individualized dosage forms. Compounding includes formulating such as mixing, blending, spraying, capsule filling, and tableting.

The present invention provides a computer-controlled apparatus comprising a central computer for receiving an individual patient prescription; a plurality of containers for storing bulk drugs; a dosing unit coupled to the central computer; and an automated compounder controlled by the central computer and connected to the dosing unit for compounding one or more of the bulk drugs into a dosage form for an individual patient prescription.

The present invention also provides a method of compounding a dosage form to fill an individual patient prescription using an apparatus in the method comprising: receiving and storing an individual patient prescription at a central computer; transferring one or more bulk drugs to an automated compounder; transmitting an instruction from the central computer to an automated compounder to compound the bulk drugs; receiving the instruction at the automated compounder; and compounding the bulk drugs into a dosage form in the automated compounder.

This invention further provides a means of effecting savings and improving quality of individualized combination and release characteristic dosage forms by a pharmacist to meet individual prescriptions even if such prescriptions are not commercially available.

The present invention further provides an apparatus and method for computer-controlled desktop compounding of bulk drugs to an individual prescription including integrated quality control procedures.

### BRIEF DESCRIPTION OF THE DRAWINGS

The features and advantages of the present invention will become more readily apparent from the following detailed description of the invention in which like elements are labeled similarly and in which:

FIG. 1 is a schematic diagram of a preferred embodiment of the present invention;

FIG. 2 is an illustration of a capsule filler for filling capsules used in connection with the present invention;

FIG. 3 is an illustration of compounding tablets used in connection with the present invention;

FIG. 4 is a flowchart of a preferred embodiment of the present invention showing a method of compounding a dosage form for an individual patient prescription;

FIG. 5 is a flowchart of a preferred method of operation of a dosing unit used in connection with the present invention; and

FIG. 6 is a flowchart showing a preferred method of operation of a quality assurance device used in connection with the present invention.

### DETAILED DESCRIPTION OF THE PREFERRED EMBODIMENTS

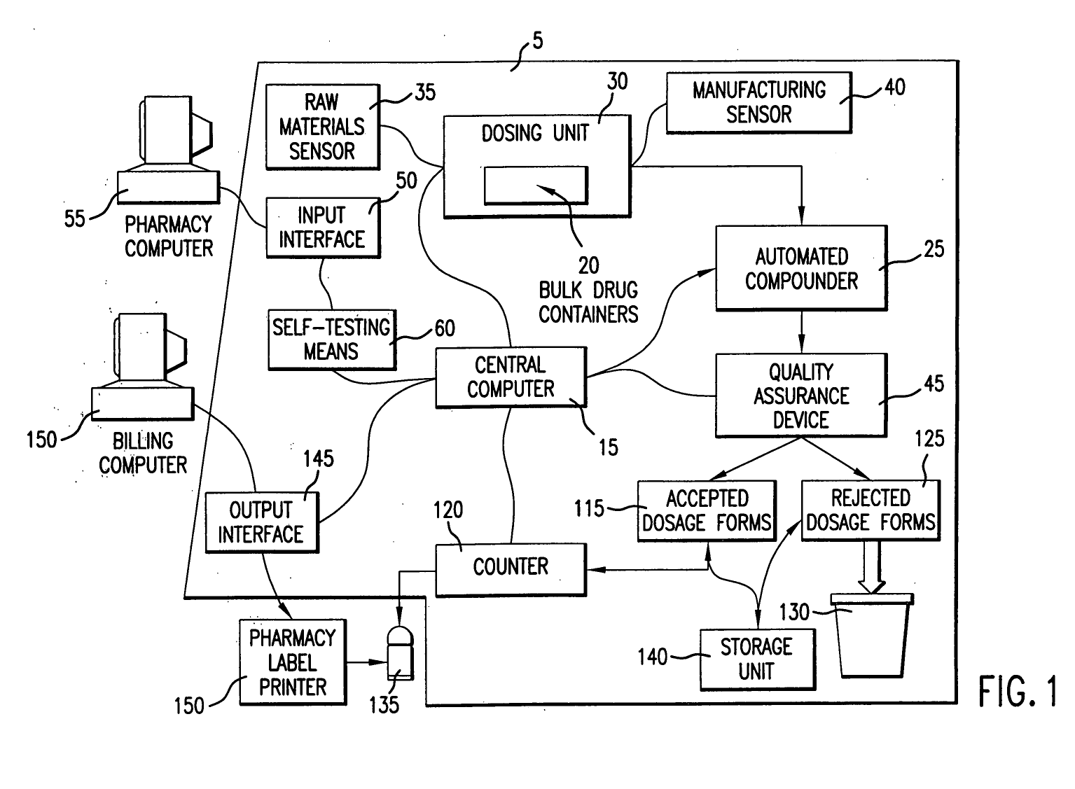

The present invention is generally an apparatus 5 comprising firmware and software controlling the compounding of bulk drugs 10 to a desired composition. FIG. 1 shows an apparatus 5 comprising a central computer 15, containers 20 containing bulk drugs 10, a dosing unit 30, and an automated compounder 25 for compounding the bulk drugs 10. The apparatus 5 preferably also includes integrated quality control devices such as a raw materials sensor 35, a manufacturing sensor 40, and a quality assurance device 45.

The central computer 15 receives and stores an individual patient prescription, controls the operation of the apparatus 5, and stores manufacturing information for each individual patient prescription.

The central computer 15 is preferably connected to an input interface 50 such as a modem, telephone, cellular phone, fax machine, Internet or other network connection. The input interface 50 may be connected to an input device 55 such as a pharmacy computer. The input device 55 receives the patient prescription and then transmits the prescription via the input interface 50 to the central computer 15. For example, a pharmacist may input an individual patient prescription into the pharmacy computer and the pharmacy computer will transmit the prescription to the central computer 15 via the input interface 50.

After receiving an individual patient prescription, the input device 55 preferably initiates a self-test of the apparatus 5. Thus, the present invention preferably includes a self-testing means 60 for testing the operation of the apparatus 5 prior to use thereof. The self-testing means 60 preferably includes a cleaning means for cleaning the apparatus 5, particularly the areas of the apparatus 5 where the bulk drugs 10 come in contact with the apparatus 5.

One or more of the bulk drugs 10 are used to manufacture dosage forms for the individual patient prescription. Preferably, two or more of the bulk drugs 10 are used to manufacture dosage forms for the individual patient prescription. The bulk drugs 10 may be in any physical form, but are preferably in the form of pharmaceutical granulations, micro-particulates, or pellets.

The bulk drugs 10 are selected according to such characteristics as stability, drug content, release characteristics, blending ratios, flow characteristics, or any other desired characteristics to provide accurate and efficient compounding. The ranges, amounts, values, and ratios can vary. The bulk drugs 10 are preferably immediate, delayed, sustained or controlled release formulations that allow for individual adjustment of release characteristics for an individual patient prescription. For example, the bulk drugs 10 may be opiates (morphine, hydromorphone, codeine, oxycodone, hydrocodone, propoxyphene), and acetaminophen sustained-release preparations.

Also, the bulk drugs 10 are bulk drug products or bulk drug intermediates that are commercially available such as through Mallinckrodt or produced by a suitable method as will be recognized by those skilled in the art. For example, controlled-release bulk drugs 10 may be produced according to the methods described in U.S. Pat. Nos. 5,286,493, 5,580,578, and 5,639,476. Sustained release bulk drugs 10 may be produced according to the methods described in U.S. Pat. Nos. 5,958,452 or 5,965,161. The final step of compounding the bulk drugs 10 described in these patented methods is preferably done by a pharmacist using the apparatus 5 of the present invention. The bulk drugs 10 may also be manufactured according to the methods described in the following Example Section.

This apparatus 5 allows the pharmacist to individually compound a drug to a physician's prescription, providing the specific combination of active agents and release characteristics desired. Thus, a pharmacist can formulate a combination product that can meet the needs of an individual patient even if such prescription is not commercially available.

Each bulk drug 10 is preferably stored in a separate container 20. The containers 20 are preferably bottles. Each container 20 is also preferably computer-encoded with the name of the bulk drug 10. A plurality of containers 20 may be stored in the apparatus 5 for use with more than one individual patient prescription.

The apparatus 5 preferably includes a dosing unit 30 coupled to the central computer 15 for storing the containers 20 and measuring and dispensing the bulk drugs 10. The dosing unit 30 may be part of the automated compounder 25 or a separate device that is connected to the automated compounder 25. The dosing unit 30 preferably houses the containers 20 which the dosing unit 30 can select and position for measuring and dispensing the bulk drugs 10. For example, the dosing unit 30 identifies and selects the encoded containers 20 of bulk drugs 10 that are needed to manufacture a dosage form for an individual patient prescription. The dosing unit 30 preferably uses a pump to dispense the bulk drugs 10 and transfer the bulk drugs 10 to an automated compounder 25.

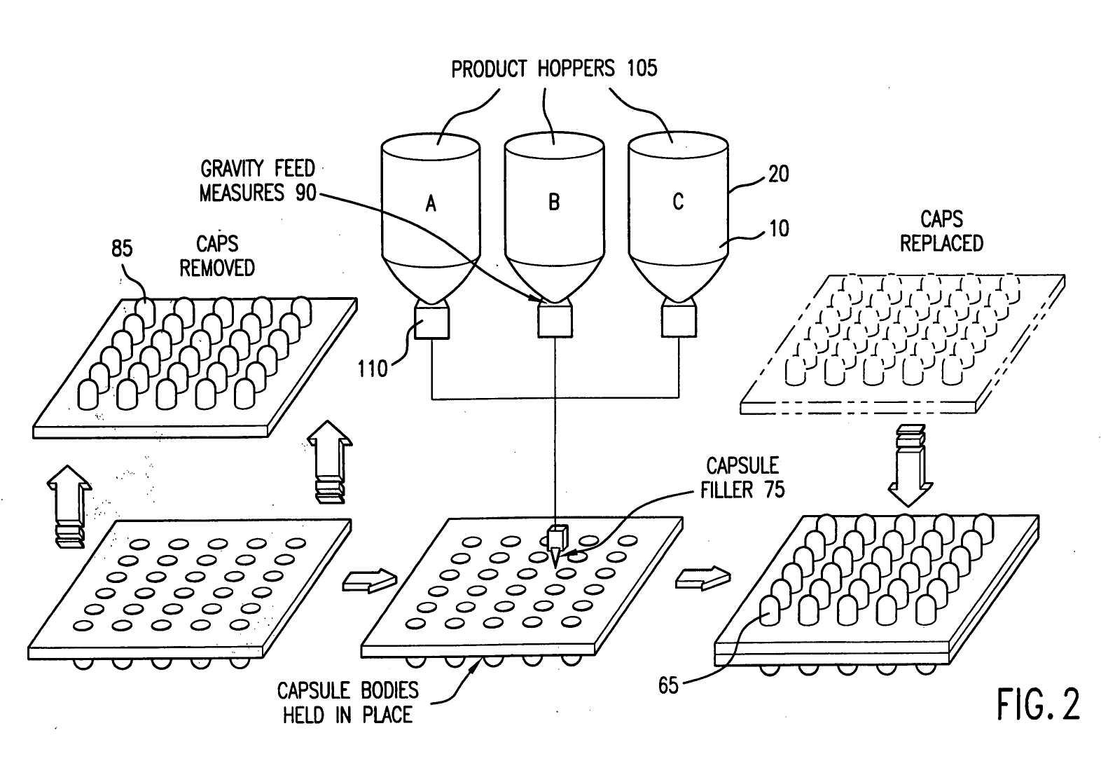

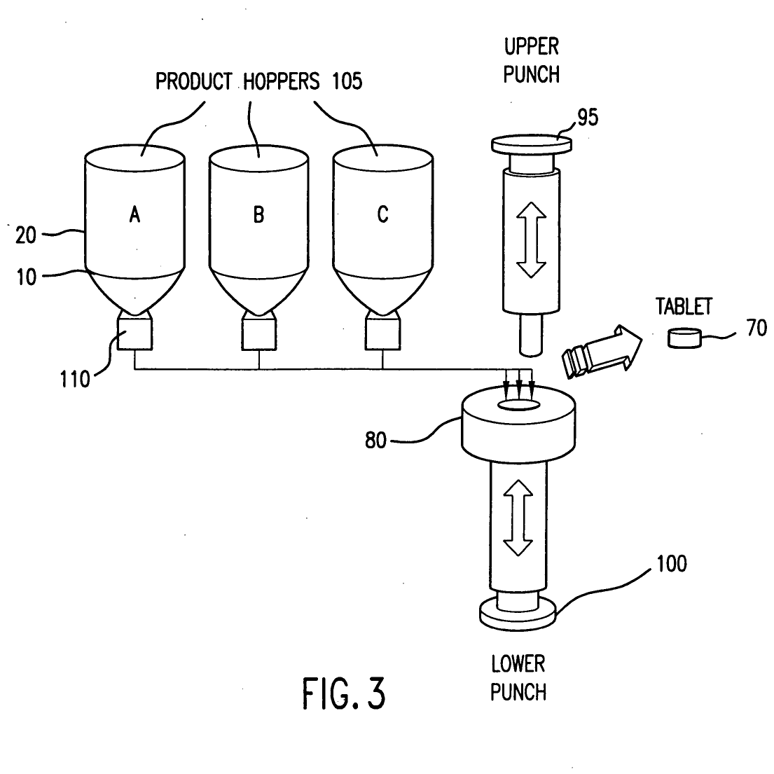

As shown in FIG. 2 and FIG. 3, the dosing unit 30 is preferably a product hopper 105 that can store the containers 20 and weigh and dispense the bulk drugs 10 from the containers 20. At the bottom of the containers 20, there is preferably a valve 110 that can be opened to dispense the bulk drugs 10 into a gravity feed measure 90 which then measures a specific amount of the bulk drugs 10 to be placed in capsules 65 or compounded into tablets 70. The amount measured by the gravity feed measure 90 is determined by the concentration of the bulk drug 10. The amount of the active drug in a given volume of bulk drug 10 material is set to be compatible with the setting on the gravity feed measure 90.

In a preferred embodiment, the apparatus 5 has an integrated manufacturing sensor 40 that monitors the operation of the dosing unit 30. After the dosing unit 30 weighs and dispenses the bulk drugs 10, the manufacturing sensor 40 verifies that the right amounts of the bulk drugs 10 were dispensed. For example, when the dosing unit 30 is a product hopper 105, the manufacturing sensor 40 will verify that the valve 110 at the bottom of the containers 20 was opened to dispense the bulk drugs 10, that the right amount of the bulk drug 10 was dispensed from the right container 20, and that the valve 110 was then closed.

In another embodiment, a raw materials sensor 35 may monitor the positioning and selection of bulk drugs 10 in the dosing unit before the dosing unit 30 weighs and dispenses the bulk drugs 10. The raw materials sensor 35 is connected to the dosing unit 30 and coupled to the central computer 15. The raw materials sensor 35 verifies that the right container 20 of bulk drug 10 is in the right position and that the right bulk drug 10 is in each container 20 before the bulk drugs 10 are measured and dispensed.

The dosing unit 30 dispenses and transfers the bulk drugs 10 to an automated compounder 25 that compounds the bulk drugs 10 into a dosage form for an individual patient prescription. The dosage form is preferably an oral dosage form such as a capsule 65 or a tablet 70. The automated compounder 25 may be a capsule filler 75 as shown in FIG. 2 or a tableter 80 as shown in FIG. 3 in which several capsules 65 or tablets 70, respectively, can be compounded. A capsule filler 75 allows for the automated removal of the caps 85 of the capsules 65, the filling of the capsules 65 using gravity feed measures 90 as the capsules 65 are held in place, and then the automated replacement of the caps 85. The tableter,80 uses an upper punch 95 and lower punch 100 to compound a tablet 70.

Before the operator of the apparatus 5 dispenses the dosage form to the patient, the dosage form preferably meet certain quality standards. In a preferred embodiment, the apparatus 5 has an integrated quality assurance device 45 to verify that the dosage form meets quality standards. The quality assurance device 45 is coupled to the compounding device and checks the quality of the dosage form by a suitable quality control test such as mass spectrometry, near infrared spectrometry, optical resolution analysis, or any other appropriate analytical method to determine the chemical properties of the dosage form. The quality assurance device 45 may also measure the weight of the dosage form.

Based on the results of the quality control tests, the quality assurance device 45 preferably accepts a dosage form meeting certain quality standards or rejects a dosage not meeting those quality standards. The quality assurance device 45 may transfer the accepted dosage form 15 to a counter 120 that counts the dosage form, or deposit the rejected dosage form 125 in a discard bin 130. After the counter 120 counts the dosage form, the dosage form may be deposited in a pharmacy prescription vial, plastic bag or other suitable output bin 135.

The information from the quality control devices is preferably stored in a separate storage unit 140. For example, the apparatus 5 may include a storage unit 140 for electronic storage of manufacturing records for a dosage form such as the data received from the quality assurance device 45 and the central computer 15. The storage unit 140 maintains records for all dosage form made by the apparatus 5 and is tamper-resistant and separate from the central computer 15.

The apparatus 5 preferably also includes an output interface 145 connected to the central computer 15. The output interface 145 is preferably connected to an output device 150 such as a pharmacy billing computer that can produce individualized patient bills; a printer that can print labels to place on a pharmacy prescription vial or individual prescription data for a patient; another computer for electronically transmitting prescription data to a patient or doctor; or any other appropriate device. The central computer is preferably connected to one or more output interfaces 145 which are connected to one or more output devices 150.

The apparatus 5 may be any feasible size. For example, the apparatus 5 may haste dimensions of less than about 3.0 feet in width by less than about 3.0 feet in length by less than about 4.0 feet in height. A floor model of the apparatus 5, for example, may have dimensions of less than about 2.5 feet in width by less than about 2.5 feet in length by less than about 3.5 feet in height. Preferably, the apparatus 5 can fit on a desktop, benchtop, tabletop, or countertop such as in a pharmacy for convenient use by a pharmacist. For example, a tabletop model of the apparatus 5 may have dimensions of less than about 2.5 feet in width by less than about 2.5 feet in length by less than about 1.5 feet in height. Also, the apparatus 5 may have any other suitable dimensions as recognized by one skilled in the art.

The apparatus 5 also is preferably enclosed within an integrated housing. It is also preferred that the parts of the apparatus 5 are integrally connected to each other.

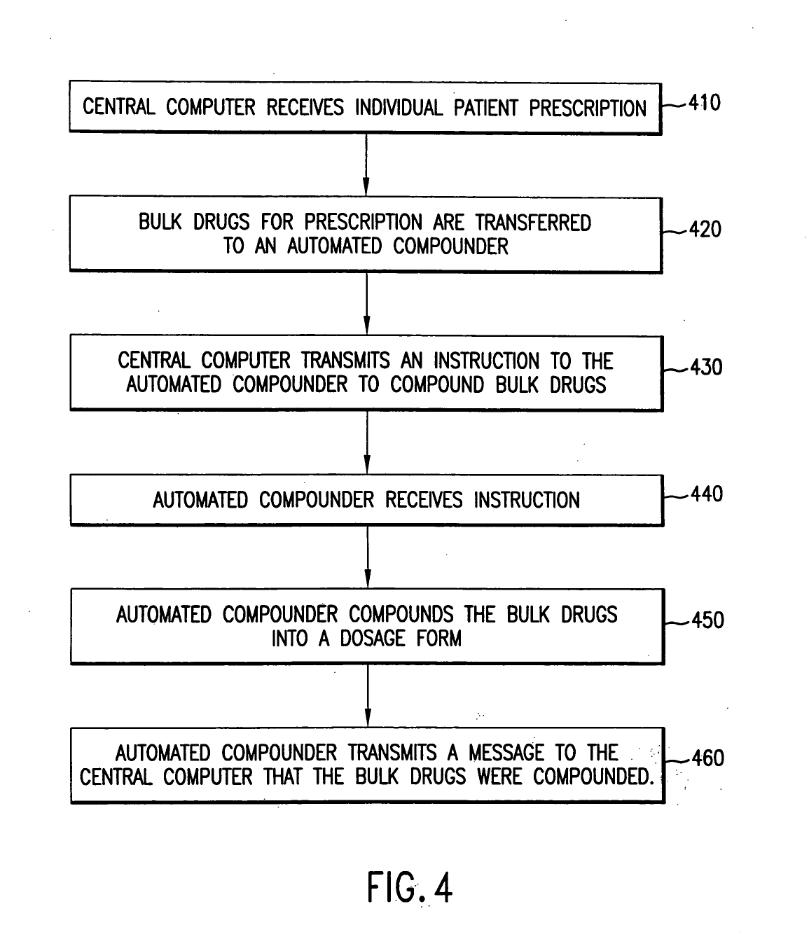

The present invention also comprises a method of compounding a dosage form for an individual patient prescription using an apparatus 5. FIG. 4 is a flow chart showing a preferred method for compounding a dosage form for an individual patient prescription.

In step 410, the central computer 15 receives and stores an individual patient prescription. The central computer 1.5 receives the individual patient prescription from any suitable source such as an input device 55 via an input interface 50 or from a user who directly enters the patient prescription into the central computer 15. Preferably, the individual patient prescription is entered into an input device 55 such as a pharmacy computer, and then transmitted from the input device 55 via an input interface 50 to the central computer 15.

After receiving an individual patient prescription, the input device 55 may initiate a self-test and/or a cleaning procedure on the apparatus 5. The method preferably includes performing a self-test on the apparatus 5 prior to use thereof. In a preferred embodiment, the self-testing is integrated with the cleaning step. The self-testing of the apparatus 5 includes testing whether the central computer 15 and any devices attached thereto are turned on and functioning properly, whether the connections between the central computer 15 and the devices are functioning properly, and whether the lines in the system have in fact been cleaned and are not clogged. The self-test verifies the position and functioning of all solenoids, stepper-motors and valves that are in each device, then acts to prepare a “dummy” dosage form whose creation verifies proper functioning.

The cleaning step preferably includes cleaning the automated compounder 25 and other areas of the apparatus 5 where the bulk drugs 10 and the dosage form come in contact using an inert drug-free cleaning excipient. In this cleaning procedure, the central computer 15 transmits an instruction to the dosing unit 30 to position the cleaning container in order to dispense the cleaning excipient. The cleaning excipient may be stored in an encoded container similar to the container 20 for the bulk drugs 10. The dosing unit 30 receives the instruction and positions the cleaning container, and sends a message to the central computer 15 that the cleaning container is in position. The central computer 15 sends an instruction to the dosing unit 30 to dispense an appropriate amount of the cleaning excipient. A pump in the dosing unit 30 dispenses the cleaning excipient and passes it through the dosing unit 30, automated compounder 25, and any other devices that are part of the apparatus 5. This cleaning step is preferably done before and after a new prescription is manufactured.

Once the cleaning and the self-testing steps have been completed, the central computer 15 transmits a message to the input device 55 that the apparatus 5 is ready for use. The input device 55 receives this message and transmits the patient prescription to the central computer 15.

In step 420, the bulk drugs 10 are transferred to the automated compounder 25. In this step, it is preferred that a plurality of containers 20 containing bulk drugs 10 are stored in a dosing unit 30 which is coupled to the central computer 15. The dosing unit 30 may be separate from or part of the automated compounder 25. The dosing unit 30 weighs and dispenses the bulk drugs 10 and then transfers the bulk drugs 10 to the automated compounder 25. The bulk drugs 10 are transferred to the automated compounder 25 by any suitable means such as a gravity shoot, a pneumatic shoot, or a feed screw.

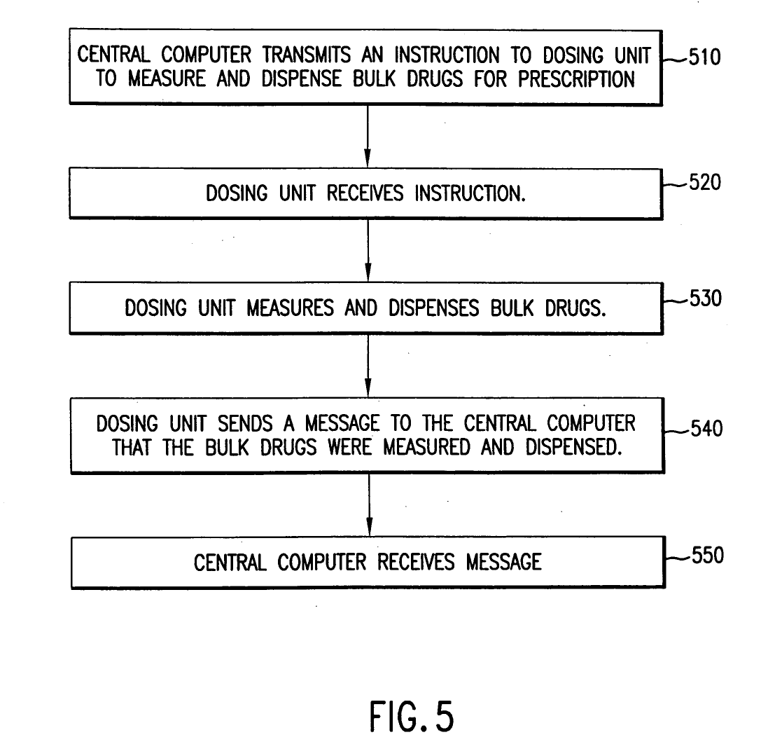

FIG. 5 shows a preferred method of operation of a dosing unit 30. In step 510 the central computer 15 transmits an instruction to a dosing unit 30 to measure and dispense the bulk drugs 10 for the individual patient prescription. In step 520, the dosing unit 30 receives the instruction from the central computer 15 to weigh and dispense the bulk drugs 10. In step 530 the dosing unit 30 weighs and dispenses the bulk drugs 10 using an appropriate method. For example, as shown in FIGS. 2 and 3, the bulk drugs 10 are measured using a gravity feed measure 90. A valve 110 at the bottom of the container 20 opens and closes to dispense the desired amount of bulk drug 10. If the dosing unit 30 is separate from the automated compounder 25, then the measured bulk drugs 10 are dispensed and transferred to the automated compounder 25. In step 540, the dosing unit 30 transmits a message to the central computer 15 that the bulk drugs 10 were measured and dispensed.

After the dosing unit 30 dispenses the bulk drugs 10 for the individual patient prescription, the central computer 15 preferably transmits an instruction to a manufacturing sensor 40 to verify that the right amounts of the bulk drugs 10 were measured and that the bulk drugs 10 were dispensed. The manufacturing sensor 40 receives the instruction from the central computer 15 and verifies and transmits a message to the central computer 15 that the right amounts of the bulk drugs 10 were dispensed. In step 550 the central computer 15 receives and stores the message that the bulk drugs 10 were dispensed.

In another embodiment, step 420 also includes steps for selecting and positioning the containers 20 of the bulk drugs 10 needed for an individual patient prescription in the dosing unit 30 before the bulk drugs 10 are measured and dispensed. In particular, the central computer 15 transmits an instruction to the dosing unit 30 to select and position the containers 20 of the bulk drugs 10. The dosing unit 30 receives the instruction and selects and positions the containers 20 of the bulk drugs 10. In such case, the containers 20 are computer encoded such that the dosing unit 30 can identify the containers 20 needed to make a particular individual patient prescription. The containers 20 are placed in position for measuring and dispensing, such as in FIGS. 2 and 3. The dosing unit 30 transmits a message to the central computer 15 that the containers 20 were selected and positioned in the dosing unit 30. The central computer 15 receives and stores the message.

Preferably, step 420 further includes one or more quality control procedures after the bulk drugs 10 are selected and positioned. For example, after the bulk drugs 10 have been selected and positioned, the central computer 15 transmits an instruction to a raw materials sensor 35 to verify that the right containers 20 contain the right bulk drugs 10 and that the containers 20 are in the right-positions in the dosing unit 30. The raw materials sensor 35 receives this instruction and then verifies and transmits a message to the central computer 15 that the right containers 20 contain the right bulk drugs 10 and that the containers 20 are in the right positions in the dosing unit 30. The central computer 15 then receives and stores the message from the raw materials sensor 35.

Referring back to FIG. 4, after the dosing unit measures and dispenses the bulk drugs 10 in step 420, the bulk drugs 10 are transferred to an automated compounder 25. The central computer 15 transmits an instruction to the dosing unit 30 to transfer the bulk drugs 10-to the automated compounder 25. The dosing unit 30 receives the instruction and transfers the bulk drugs 10 to the automated compounder 25.

In step 430, in an appropriate time interval after the central computer 15 commands the dosing unit 30 to transfer the bulk drugs 10 to the automated compounder 25, the central computer 15 transmits an instruction to an automated compounder 25 to compound the bulk drugs 10 into a dosage form for filling the individual patient prescription. The automated compounder 25 receives the instruction in step 440 and compounds the bulk drugs 10 into a dosage form in step 450. In this step, the bulk drugs 10 are mixed in any desired method. For example, a melt extrusion method such as those methods described in U.S. Pat. Nos. 5,958,452 or 5,965,161 may be used. In step 460, the automated compounder 25 then transmits a message to the central computer 15 that the bulk drugs 10 were compounded into a dosage form. The central computer 15 receives and stores the message. The central computer 15 may send an instruction to the automated compounder 25 to deposit the dosage form in an output bin 135 or transfer the dosage form to another device such as a quality assurance device 45. The dosage form may be transferred via a solenoid or a stepper-motor.

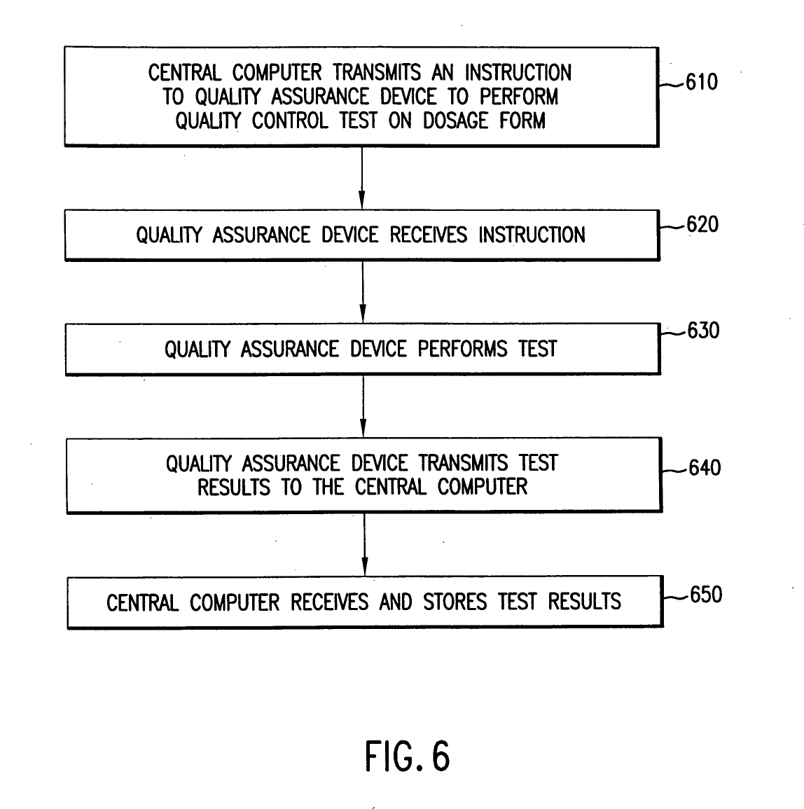

After the bulk drugs 10 have been compounded into a dosage form, the present invention preferably includes performing at least one quality control test to verify-the chemical identity of a dosage form. FIG. 6 is a flowchart showing a preferred method of operation of a quality assurance device 45. The quality assurance device 45 is preferably connected to the automated compounder 25 to facilitate transferring the dosage form from the automated compounder 25 to the quality assurance device 45 for a prompt analysis of the chemical composition of the dosage form. In step 610, the central computer 15 transmits an instruction to a quality assurance device 45 to perform a quality assurance test to verify the chemical identity of a dosage form. The quality assurance device 45 receives the instruction in step 620 and the quality assurance device 45 performs a quality assurance test to verify the chemical identity of a dosage form in step 630. Suitable tests include mass spectrometry, near infra-red spectrometry, optical resolution analysis, or any other appropriate method of analyzing the chemical properties of the dosage form. The quality assurance device 45 preferably analyzes the near-infrared characteristics of the dosage form. The quality assurance device 45 may also measure the weight of the dosage form. The quality assurance device 45 may store the results of the quality assurance test in the quality assurance device 45. In step 640, the quality assurance device 45 transmits the test results to the central computer 15 and in step 650 the central computer 15 receives and stores the test results.

The central computer 15 may also have software for determining whether the dosage form meets the required quality standards for dispensing the dosage form to a patient, and the central computer 15 may then determine whether a dosage form should be rejected and discarded or accepted for filling the individual patient prescription. Once the central computer 15 makes this determination, the central computer 15 transmits an instruction to the quality assurance device 45 to accept a dosage form meeting certain quality standards or reject a dosage form that do not meet those certain quality standards. In particular, the central computer 15 transmits an instruction to the quality assurance device 45 to transfer an accepted dosage form 115 to a counter 120 for counting or to discard a rejected dosage form 125. The quality assurance device 45 receives the instruction from the central computer 15. The quality assurance device 45 transfers the accepted dosage form 115 to a counter 120 or transfers the rejected dosage form 125 to a suitable discard bin 130. The dosage forms are transferred from the quality assurance device by any suitable means such as a gravity shoot, a worm screw, or a pneumatic tube. Then the quality assurance device 45 transmits a message to the central computer 15 that the dosage form has been accepted or rejected, and the central computer 15 receives and stores the message.

The counter 120 counts the accepted pill 115 and transmits a message to the central computer 15 indicating that an accepted pill 115 has been counted. After passing through the counter 120, the dosage form may then be deposited in a pharmacy prescription vial, a plastic bag, or other suitable output bin 135. The apparatus 5 can repeat the method to produce any given number of dosage forms.

In a preferred embodiment, the method includes storing electronic manufacturing records for the dosage form in a tamper-resistant storage unit 140 attached to the quality assurance device 45. The central computer 15 and the quality assurance device 45 may transmit the manufacturing records for an individual patient prescription to the storage unit 140 for electronic storage of the manufacturing records. The central computer 15 may send an instruction to the quality assurance device 45 to transmit information to the storage unit 140.

The method preferably comprises transmitting the individual patient prescription data for the accepted dosage form 115 from the central computer 15 to an output device 150 such as a printer or a pharmacy billing computer. The printer is preferably used for printing pharmacy labels to place on a prescription vial. The pharmacy billing computer preferably generates individualized patient bills. In addition, once the dosage forms for the prescription have been manufactured, the central computer 15 may initiate another cleaning step.

The apparatus and method of the present invention may be used to produce any suitable composition including drugs that are not commercially available. For example, the method and apparatus are suitable for manufacturing drugs having individualized release characteristics for an individual patient or for appropriate combinations of several drugs to fill an individual patient's prescription.

### EXAMPLES

In order to further illustrate the present invention and the advantages thereof, the following specific examples are given, it being understood that some are intended only as illustrative and in no way as limitative.

### Example 1

The following data shows a method of formulating bulk hydromorphone HCl controlled release pellets which a pharmacist then uses with the apparatus of the present invention to compound an individualized dosage form.

1. The bulk Hydromorphone HCl controlled release pellets were manufactured and tested by the manufacturer according to the formula a, process b and tested including dissolution by method c.

a. FORMULA

| Ingredient | Amt/unit (mg) |
|---|---|
| Hydromorphone HCl | 12.0 |
| Eudragit RSPO* | 76.5 |
| Ethylcellulose | 4.5 |
| Stearyl Alcohol | 27.0 |
| Total | 120.0 |

*Aminoalkyl Methacrylate Copolymer RS″ JPE or Amino Methacrylate Copolymer, Type B, NF manufactured by Rohm GmbH.

b. PROCESS:

1. Pass Stearyl Alcohol flakes through an impact mill.

2. Blend the Hydromorphone HCl, Eudragit, Ethycellulose and milled Stearyl Alcohol in a twin shell blender.

3. Continuously feed the blended material into a twin screw extruder and collect the resultant strands on a conveyor.

4. Allow the strands to cool a Conveyor.

5. Cut the cooled strands into pellets using a Pelletizer.

6. Screen the pellets and collect desired sieve portion.

c. DISSOLUTION METHOD

1. Apparatus—USP Type I (Basket), 100 rpm at 37° C.

2. Sampling Time: 1, 2, 4, 8, 12, 18, 24

3. Media: 900 mL (USP) SIF+3 g NaCl/L

4. Analytical Method: High Performance Liquid Chromatography

Results:

| | Time (hour) | | | | | | |
|---|---|---|---|---|---|---|---|
| | 1 | 2 | 4 | 8 | 12 | 18 | 24 |
| Mean weight % | 12.6 | 23.8 | 43.2 | 69.5 | 84.7 | 96.5 | 100.8 |

2. The bulk pellets are then supplied to the pharmacist who uses the apparatus to fill the appropriate sized and identified capsules at the appropriate fill weight to produce the correct strength Hydromorphone HCl controlled release capsules.

| Strength | Capsule Size + ID | Fill Weight of bulk pellets |
|---|---|---|
| 12 mg | Size 2 Swedish Orange | 120 mg |
| 16 mg | Size 2 Flesh Opaque | 160 mg |
| 24 mg | Size 1 Powder Blue | 240 mg |
| 32 mg | Size 0 White | 320 mg |

### Example 2

The following data shows a method of formulating bulk morphine sulphate controlled release (MSCR) beads which a pharmacist then uses with the apparatus of the present invention to compound an individualized dosage form.

1. The bulk morphine sulphate controlled release beads were manufactured and tested by the manufacturer according to the formula a, process b and tested including dissolution by method c.

a. FORMULA

| | | Amt/unit |
|---|---|---|
| | Ingredients | (mg) |
| Step 1. Drug loading | Morphine sulfate | 60.0 |
| (MSCR beads) | | |
| | Lactose impalpable¹ | 12.0 |
| | Eudragit RS30D (dry)² | 2.0 |
| | Povidone³ | 3.5 |
| | Nupareil PG 30/35⁴ | 16.8 |
| | Opadry blue⁵ | 4.9 |
| | Water | |
| Step 2. Controlled | MSIR beads | 99.2 |
| Release Coat | (formulation of Step 1) | |
| | Eudragit RS 30D (dry) | 4.712 |
| | Eudragit RL 30D (dry)⁶ | 0.248 |
| | Triethyl citrate | 0.992 |
| | Talc | 1.884 |
| | Opadry blue | 5.639 |
| | Water | |
| Total | | 112.675 |

¹Manufactured by Hollandse Melksuikerfabriek, Holland.
²Amino Methacrylate Copolymer, Type B, NF manufactured by Rohm GmbH.
³Polyvinylpyrrolidone manufactured by ISP Technologies, Texas.
⁴Sugar spheres NF manufactured by Chr. Hansen, Vineland, NJ.
⁵Manufactured by Colorcon Inc., West Point, PA.

⁶Amino Methacrylate Copolymer, Type A, NF manufactured by Rohm GmbH.

b. PROCESS

1. Disperse povidone and Eudragit RS30D in water. Blend morphine sulfate and lactose.

2. Load beads in Rotor processor. Spray the drug powder blend and the binder solution onto beads.

3. Film-coat the above beads in the Rotor processor.

4. Disperse Eudragit RS30D, RL 30D, Triethyl citrate, talc and triethyl citrate in water. Coat the above beads in a fluid bed coated with Wurster insert.

5. Cure the beads.

c. DISSOLUTION METHOD

1. Apparatus—USP Type II (paddle), 100 rpm at 37° C.

2. Sampling time—1, 2, 4, 12, 24, and 36 hours.

3. Media—700 ml SGF for first 55 min then converted to 900 ml SIF

4. Analytical method—High performance liquid chromatography.

Results and Discussion:

The MSCR beads were found to have the following dissolution results:

| | Time (hr) | | | | | | |
|---|---|---|---|---|---|---|---|
| | 1 | 2 | 4 | 8 | 12 | 18 | 24 |
| Mean weight % | 4 | 8 | 23 | 49 | 70 | 83 | 85 |
| dissolved | | | | | | | |

2. The bulk beads are supplied to the pharmacist who uses the apparatus to fill the appropriate sized and identified capsules at the appropriate fill weight to produce the correct strength morphine sulphate controlled release capsules.

| Strength | Capsule Size and ID | Fill Weight of Bulk Beads |
|---|---|---|
| 30 mg | Size 4, Amethyst | 56.338 mg |
| 60 mg | Size 3, Orange | 112.675 mg |
| 120 mg | Size 1 , Iron Gray | 225.350 mg |
| 200 mg | Size EOC - Blue Green | 375.583 mg |

### Example 3

The following data shows a method of formulating bulk hydromorphone immediate release granulations which a pharmacist then uses with the apparatus of the present invention to compound an individualized dosage form.

1. The bulk Hydromorphone HCl immediate release granulation were manufactured and tested by the manufacturer according to the formula a, process b, and tested including dissolution by method c.

a. FORMULA

| Ingredient | Amt/Unit (mg) |
|---|---|
| Hydromorphone HCl | 4.0 |
| Starch 1500 G¹ | 23.0 |
| Spray Dried Lactose² | 34.0 |
| Avicel PH 102³ | 26.75 |
| Ac-di-sol⁴ | 1.0 |
| Talc | 1.0 |
| Magnesium Stearate | 0.25 |
| | 90.0 |

¹Manufactured by Colorcon, Indianapolis, IN.
²Manufactured by Wisonsin Dairy/Formost Farms USA Cooperative.
³Microcrystalline cellulose made by FMC Corp., Newark, Del.
⁴Croscarmellose sodium made by FMC Corp, Newark, Del.

b. PROCESS

1. In a suitable sized mixer, transfer ¼ of the starch 1500, all the Hydromorphone HCl, and about ¼ of the starch 1500 blend for 5 minutes and screen through a 20 mesh screen.

2. Pass the remaining starch 1500, all the spray dried lactose, microcrystalline cellulose, and Ac-di-sol through a 20 mesh screen and add to the mixer and blend for 30 minutes.

3. Transfer the talc and blend for 5 minutes.

4. Transfer the magnesium stearate and blend for 90 seconds.

c. DISSOLUTION METHOD

1. Apparatus: USP Type 2 (paddles) 50 rpm at 37° C.

2. Sampling time: 45 minutes.

3. Media: 500 ml 0.1N HCL.

4. Analytical method: High performance Liquid chromatography

Results

Time (minutes) 45

Mean weight % dissolved 100

2. The bulk product is processed by the pharmacists using the apparatus to compress the bulk granulation at the appropriate weight to produce the correct strength Hydromorphone HCl Immediate Release tablets.

| Strength | Compression Weight |
|---|---|
| 2 mg | 45 mg |
| 4 mg | 90.0 mg |
| 8 mg | 180 mg |

All documents cited herein are incorporated by reference in their entireties for all purposes.

One skilled in the art will appreciate that the present invention can be practiced in ways other than the described embodiments, which are presented for purposes of illustration and not limitation.

What is claimed is:

1. An apparatus for compounding drugs into a dosage form to fill an individual patient prescription comprising:
a central computer for receiving an individual patient prescription;
a plurality of containers for storing bulk drugs;
a dosing unit coupled to the central computer; and
an automated compounder controlled by the central computer and connected to the dosing unit for compounding one or more of the bulk drugs into a dosage form for the individual patient prescription wherein the dosing unit transfers the bulk drugs to the automated compounder.

2. The apparatus of claim 1 wherein the bulk drug is a bulk drug product or bulk drug intermediate.

3. The apparatus of claim 1 wherein the bulk drugs have immediate, delayed, sustained, or controlled release characteristics.

4. The apparatus of claim 1 wherein the bulk drug is in the form of pharmaceutical granulations or micro-particulates for immediate or controlled release.

5. The apparatus of claim 1 wherein the dosage form is a capsule or tablet.

6. The apparatus of claim 1 further comprising an input device for receiving the individual patient prescription and transmitting the prescription to the central computer via an input interface.

7. The apparatus of claim 6 wherein the input device is a pharmacy computer.

8. The apparatus of claim 6 wherein the input device includes a self-testing means for testing the operation of the apparatus prior to use thereof.

9. The apparatus of claim 1 wherein the automated compounder is a tableter or a capsule filler.

10. The apparatus of claim 1 wherein the dosing unit measures and dispenses the bulk drugs.

11. The apparatus of claim 10 further comprising a raw materials sensor connected to the dosing unit for verifying that the position of the containers in the dosing unit and identity of the bulk drugs in the containers are correct before the bulk drugs are measured and dispensed.

12. The apparatus of claim 10 further comprising a manufacturing sensor connected to the dosing unit for verifying that the right amounts of the bulk drugs were dispensed.

13. The apparatus of claim 1 further comprising a quality assurance device coupled to the compounder for performing a quality assurance test to verify the chemical identity of the dosage form in order to accept or reject the dosage form.

14. The apparatus of claim 13 further comprising a counter attached to the quality assurance device and coupled to the central computer for counting the accepted dosage form.

15. The apparatus of claim 13 further comprising a storage unit coupled to the quality assurance device for electronic storage of manufacturing records for the dosage form.

16. The apparatus of claim 1 further comprising an output device for receiving and storing prescription information from the central computer via an output interface.

17. The apparatus of claim 16 wherein the output device is a computer for generating individual bills.

18. The apparatus of claim 16 wherein the output device is a printer for printing labels to place on a vial for an individual patient prescription.

19. The apparatus of claim 1 wherein the apparatus is desktop sized.

20. A method of compounding a dosage form for an individual patient prescription using an apparatus comprising:
receiving and storing an individual patient prescription at a central computer;
transferring one or more bulk drugs needed for the individual patient prescription to an automated compounder;
transmitting an instruction from the central computer to an automated compounder to compound the bulk drugs into a dosage form;
receiving an instruction from the central computer at the automated compounder to compound the bulk drugs; and
compounding the bulk drugs in the automated compounder.

21. The method of claim 20 further comprising:
transmitting a message to the central computer from the automated compounder that the bulk drugs were compounded into a dosage form.

22. The method of claim 20 wherein the bulk drug is a bulk drug product or bulk drug intermediate.

23. The method of claim 20 wherein the bulk drugs are immediate, delayed, sustained, or controlled release formulations.

24. The method of claim 20 wherein the bulk drug is in the form of pharmaceutical granulations or micro-particulates for immediate or controlled release.

25. The method of claim 20 wherein the bulk drugs are compounded to form a dosage form having individualized release characteristics.

26. The method of claim 20 wherein the dosage form is a capsule or tablet.

27. The method of claim 20 further comprising performing a self-test of the operation of the apparatus prior to use thereof.

28. The method of claim 20 further comprising cleaning the automated compounder and other areas of the apparatus where the bulk drugs and the dosage form come in contact using a cleaning excipient.

29. The method of claim 20 further comprising:
storing a plurality of containers containing bulk drugs in a dosing unit connected to the automated compounder;
transmitting an instruction from the central computer to the dosing unit to measure and dispense the bulk drugs;
receiving the instruction from the central computer at the dosing unit to measure and dispense the bulk drugs;
measuring and dispensing the bulk drugs;
transmitting a message to the central computer from the dosing unit that the bulk drugs were measured and dispensed;
receiving and storing at the central computer the message that the bulk drugs were measured and dispensed;
transmitting an instruction from the central computer to the dosing unit to transfer the measured bulk drugs to the automated compounder
receiving the instruction from the central computer at the dosing unit to transfer the bulk drugs to the automated compounder;
transferring the bulk drugs from the dosing unit to the automated compounder; and
transmitting a message from the dosing unit to the central computer that the bulk drugs have been transferred to the automated compounder.

30. The method claim 29 further comprising:
transmitting an instruction from the central computer to a manufacturing sensor to verify that the right amounts of the bulk drugs were dispensed;
receiving an instruction from the central computer at the manufacturing sensor to verify that the right amounts of the bulk drugs were dispensed;
verifying and transmitting a message to the central computer from the manufacturing sensor that the right amounts of the bulk drugs were dispensed; and
receiving and storing a message from the manufacturing sensor that the right amounts of the bulk drugs were dispensed.

31. The method of claim 29 further comprising:
transmitting an instruction from the central computer to the dosing unit to select and position the containers of the bulk drugs before the dosing unit measures and dispenses the bulk drugs;
receiving an instruction at the dosing unit from the central computer to select and position the containers of the bulk drugs;
selecting and positioning the containers of the bulk drugs in the dosing unit;
transmitting a message to the central computer that the containers were selected and positioned in the dosing unit; and
receiving and storing a message at the central computer that the containers were selected and positioned in the dosing unit.

32. The method of claim 31 further comprising:
transmitting an instruction to a raw material sensor to verify that the right containers contain the right bulk drugs and that the containers are in the right positions in the dosing unit;
receiving the instruction at the raw material sensor;
verifying and transmitting a message from the raw materials sensor to the central computer that the right containers contain the right bulk drugs and that the containers are in the right positions in the dosing unit; and
receiving and storing the message from the raw materials sensor at the central computer that the right containers contain the right bulk drugs and that the containers are in the right positions in the dosing unit.

33. The method of claim 20 further comprising:
transmitting an instruction from the central computer to a quality assurance device connected to the automated compounder to perform a quality control test to verify the chemical identity of a dosage form;
receiving the instruction from the central computer at the quality assurance device;
performing the quality control test and storing the results in the quality assurance device;
transmitting from the quality assurance device to the central computer the results of the quality control tests; and
receiving and storing in the central computer the results of the quality assurance test.

34. The method of claim 33 wherein the quality control test is mass spectrometry, near infra-red spectrometry, or optical resolution analysis.

35. The method of claim 33 further comprising:
transmitting an instruction from the central computer to the quality assurance device to accept or reject the dosage form wherein the quality assurance device discards the rejected pill or transfers the accepted pill to a counter for counting;
receiving an instruction from the central computer at the quality assurance device to accept or reject the dosage form;
transferring the accepted pill from the quality assurance device to a counter or transferring a rejected pill from the quality assurance device to a discard bin; and
transmitting a message to the central computer from the quality assurance device that the dosage form has been accepted or rejected.

36. The method of claim 33 further comprising storing electronic manufacturing records for the dosage forms in a storage unit attached to the quality assurance device.

37. The method of claim 20 further comprising transmitting the individual patient prescription data for the accepted dosage form from the central computer to an output device.

38. The method of claim 37 wherein the output device is a printer or a billing computer.
